(19) United States
(12) Patent Application Publication
(10) Pub. No.: US 2024/0215587 A1
(43) Pub. Date: Jul. 4, 2024

(54) COMPOSITION FOR PREVENTING AND TREATING BACTERIAL LEAF STREAK OF RICE, AND PREPARATION METHOD THEREFOR AND APPLICATION THEREOF

(71) Applicants: PLANT PROTECTION RESEARCH INSTITUTE OF GUANGDONG ACADEMY OF AGRICULTURAL SCIENCES, Guangzhou, Guangdong (CN); GUANGDONG BRANCH OF CHINA TOBACCO GENERAL CO., LTD., Guangzhou, Guangdong (CN)

(72) Inventors: Qiyun YANG, Guangzhou, Guangdong (CN); Zheng LU, Guangzhou, Guangdong (CN); Birun LIN, Guangzhou, Guangdong (CN); Dayuan SUN, Guangzhou, Guangdong (CN); Jingxin ZHANG, Guangzhou, Guangdong (CN); Huifang SHEN, Guangzhou, Guangdong (CN); Xiaoming PU, Guangzhou, Guangdong (CN); Yonghua LV, Guangzhou, Guangdong (CN); Haibin DENG, Guangzhou, Guangdong (CN)

(21) Appl. No.: 18/548,989

(22) PCT Filed: Mar. 9, 2021
(86) PCT No.: PCT/CN2021/079632

§ 371 Date: Sep. 5, 2023

(30) Foreign Application Priority Data
Mar. 10, 2020 (CN) 202010160189.6

(51) Int. Cl. A01N 59/20; A01N 33/12; A01P 1/00

(52) U.S. Cl. CPC A01N 59/20; A01N 33/12; A01P 1/00

(57) ABSTRACT

A composition for preventing and treating bacterial leaf streak, and a preparation method therefor and an application thereof. The composition includes the following components in percentage by weight: 10-15 parts of dodecyl dimethyl benzyl ammonium bromide, 15-20 parts of copper sulfate pentahydrate, 20-25 parts of 84 disinfectant, and 40-55 parts of water. The composition is diluted and then may be used for rice seed soaking so as to prevent rice bacterial leaf streak, or is sprayed onto rice leaves so as to prevent and treat rice bacterial leaf streak. The application method of the composition is simple and convenient to operate, and solves the problem of the shortage of a prevention and treatment drug of rice bacterial leaf streak.

### TECHNICAL FIELD

The present invention is involved in the field of agricultural production, in particular relates to a composition for controlling bacterial leaf streak of rice and a preparation method and applications thereof.

### BACKGROUND

With the adjustment of crop industry structure and the invasion of foreign pests, major crop diseases have occurred frequently in recent years. Among them, bacterial leaf streak and bacterial leaf blight of rice in food crops, canker of citrus in fruit trees, and bacterial wilt of solanaceae vegetable in melons and vegetables etc., have caused serious losses on these crops. At present, the prevention and control of plant diseases still mainly relies on chemical pesticides in agricultural production. Although the control of the bacterial disease is difficult and the caused losses are serious, the number of the registered drugs used for controlling the bacterial diseases in China is still not enough. By the end of October 2018, there are about 10.900 fungicide products registered in China. However, only 280 agentias for controlling bacterial diseases were registered, accounting for 2.6% of the fungicide products. Facing the threat from bacterial diseases, the control with agentias is irreplaceable. In the future, the crop area with the occurrence of bacterial diseases may continue to increase, therefore the developing prospect of the professional drugs for control is well. Particularly, the withdrawal of streptomycin sulfate and the like has left greater space for the market.

Bacterial leaf streak of rice caused by Xanthomonas oryzaes pv. Oryzicola is one of the important quarantine plant diseases in China, and also an important disease in rice regions in tropical and subtropical area. The characteristics in its occurrence are epidemical, explosive and destructive. The disease is first found in Guangdong province of China in 1957, and then determined as bacterial leaf streak of rice by Zhongda Fang et al. Germs of bacterial leaf streak of rice mainly overwinter on diseased paddy and straw of diseased rice. Pathogens initially infect the seeds, spread over in long distances along with seed transport. Pathogens contact the seedlings mainly through irrigation water and rainwater, and invade into the plants through stomata and wounds. After invasion, the pathogens propagate under stomata, spread into the cell gap in parenchyma and extend longitudinally to form streaks. The bacterial ooze spilled out of the spots on diseased plants in the field continues to spread by wind and rainfall water, and re-infect the other rice plants, causing the spread of disease. In recent years, as hybrid rice is promoted in large scale and the propagated seeds were transported from south to north, the occurrence area of bacterial leaf streak of rice has been constantly increasing, and detriment has increased year by year. Until now; this disease has occurred in the whole southern rice region, and has been seriously threating the high yield and stable yield in rice production. There is still a lack of specific pesticides for controlling bacterial leaf streak of rice. As Streptomycin and Secazole etc. previously used in common were withdrawn from the market, it is very necessary to develop a new type of efficient pesticide with low toxicity and low residue.

### SUMMARY

A primary object of the present invention is to overcome the shortcomings and deficiencies of the prior art and to provide a composition for controlling bacterial leaf streak of rice.

Another object of the present invention is to provide a method for preparing the composition for controlling bacterial leaf streak of rice.

Still another object of the invention is to provide an application of the composition for controlling bacterial leaf streak of rice.

The object of the present invention is realized by a technical solution as followed: a composition for controlling bacterial leaf streak of rice, comprises the following components in percentage by weight: 10-15 parts of dodecyl dimethyl benzyl ammonium bromide, 15-20 parts of copper sulfate pentahydrate, 20-25 parts of 84-disinfectant, and 40-55 parts of water.

The composition for controlling bacterial leaf streak of rice, preferably comprises the following components in percentage by weight: 10-13 parts of dodecyl dimethyl benzyl ammonium bromide, 15-18 parts of copper sulfate pentahydrate, 20-23 parts of 84-disinfectant, and 46-55 parts of water.

The composition for controlling bacterial leaf streak of rice, more preferably comprises the following components in percentage by weight: 10-12.5 parts of dodecyl dimethyl benzyl ammonium bromide, 15-17.5 parts of copper sulfate pentahydrate, 20-22.5 parts of 84-disinfectant, and 47.5-55 parts of water.

The composition for controlling bacterial leaf streak of trice, most preferably comprises the following components in percentage by weight: 12.5 parts of dodecyl dimethyl benzyl ammonium bromide, 17.5 parts of copper sulfate pentahydrate, 22.5 parts of 84-disinfectant, and 47.5 parts of water.

The dodecyl diethyl benzyl ammonium bromide can be commercially available dodecyl dimethyl benzyl ammonium bromide with a content of 95% or more.

The copper sulfate pentahydrate is crystallized copper sulfate pentahydrate.

The method for preparing the composition for controlling bacterial leaf streak of rice, comprises the following steps:
(1) adding copper sulfate pentahydrate into water, and stirring and dispersing evenly at 50-60° C., to obtain a copper sulfate solution:
(2) adding dodecyl dimethyl benzyl ammonium bromide into the copper sulfate solution prepared in step (1), and stirring and mixing evenly; to obtain a transparent liquid A: and
(3) adding 84-disinfectant into the transparent liquid A prepared in step (2), and stirring and mixing evenly, to obtain the composition for controlling bacterial leaf streak of rice.

The stirring in step 1 is performed under 100-200 rpm for 40-50 min, preferably at 200 rpm for 40-50 min.

The stirring in step 2 is performed under 100-200 rpm for 15-30 min, preferably at 100-200 rpm for 15-30 min at room temperature.

The stirring in step 3 is performed under 100-200 rpm for 15-30 min, preferably at 100-200 rpm for 15-30 min at 25-30° C.

The compositions for controlling bacterial leaf streak of rice is applied in preparing a pesticide preparation for controlling bacterial leaf streak of rice.

The pesticide preparation includes aqueous agentias etc.

The compositions for controlling bacterial leaf streak of rice are applied in the control of bacterial leaf streak of rice.

In the application of the composition in the control of bacterial leaf streak of rice, the composition for controlling bacterial leaf streak of rice is diluted by 500-2000 times, and used for controlling bacterial leaf streak of rice through rice seed soaking or spraying onto rice leaves.

The multiple for dilution of the composition for controlling bacterial leaf streak of rice is preferably 500-1500 times, more preferably 1000-1500 times, and most preferably 1500 times. The time used for the rice seed soaking is preferably 24 hours.

The usage of the diluted composition for controlling bacterial leaf streak of rice is preferably 50 kg/mu.

The present invention has the following advantages and effects in comparison to the prior art:

The present invention provides a composition that can be used for the control of bacterial leaf streak of rice. The composition is an aqueous agentia formed of water, dodecyl dimethyl benzyl ammonium bromide, copper sulfate pentahydrate and 84-disinfectant, and prepared according to a certain ratio and method. Development of pesticide agents with better effect in controlling rice bacterial leaf streak disease could be the solution for the problem, lack of pesticides for bacterial leaf streak of rice. The preparation and application of the composition is easy to operate, low in costs, and effective, and thus can be used in in agricultural production, scientific research and many other fields. Additionally, it has a great practical value in a practical agricultural production, and helps to reduce the food losses caused by diseases more economically and environmentally.

### DETAILED DESCRIPTION THE INVENTION

The invention is described in further detail in combination with examples, but the embodiment of the invention is not limited thereto. Unless specifically stated, the reagents and methods used in the present invention are conventional reagents and methods in this technical field, and the reagents used in the present invention are commercially available unless specifically stated.

The dodecyl diethyl benzyl ammonium bromide (95%, V/V) involved in the present invention is purchased from Shandong Lanving Chemical Technology Co., Ltd.: 84-disinfectant (with a effective content of Chlorine of 5%-7%) is a medical disinfectant, purchased from Shantou Yaqi Trading Co., Ltd.: and copper sulfate pentahydrate is a crystalline copper sulfate pentahydrate, purchased from Guangzhou Donghui Trading Co., Ltd.

### Example 1

1000 g dodecyl dimethyl benzyl ammonium bromide, 1500 g copper sulfate pentahydrate, 2000 ml of 84-disinfectant, and 5,500 ml clean water are weighed and taken.

Preparation method is as follows:
in the first step, 5500 ml of water and 1500 g of copper sulfate pentahydrate are put in a stirring apparatus and dispersed evenly (at 50° ° C., under 200 rpm, and for 40 min) to obtain a copper sulfate solution:
in the second step, 1000 g of dodecyl dimethyl benzyl ammonium bromide is added into the copper sulfate solution made in the first step, and stirred under 200 rpm for 30 min at room temperature until the solution becomes a transparent liquid; and
in the third step, the solution obtained in the second step is added into the reactor and 2000 ml of 84-disinfectant is added into the above solution, and the mixture is stirred under 200 rpm for 30 min and at 25° ° C. to obtain a composition A.

### Example 2

1250 g of dodecyl dimethyl benzyl ammonium bromide, 1750 g of copper sulfate pentahydrate, 2250 ml of 84-disinfectant, and 4750 ml of clean water are weighed and taken.

Preparation method is as follows:
in the first step, 4750 ml of water and 1750 g of copper sulfate pentahydrate are put in a stirring apparatus and dispersed evenly under 200 rpm for 45 min at 55° C., to obtain a copper sulfate solution:
in the second step, 1250 g of dodecyl dimethyl benzyl ammonium bromide is added into the copper sulfate solution made in the first step, and stirred under 100 rpm for 20 min at room temperature until the solution becomes a transparent liquid; and in the third step, the solution obtained in the second step is added into the reactor and 2250 ml 84-disinfectant at is added into the above solution, and the mixture is stirred under 100 rpm for 15 min at 30° ° C. to obtain a composition B.

### Example 3

1500 g of dodecyl dimethyl benzyl ammonium bromide, 2000 g of copper sulfate pentahydrate, 2500 ml of 84-disinfectant, and 4000 ml of clean water are weighed and taken.

Preparation method is as follows:
in the first step, 4000 ml of water and 2000 g of copper sulfate pentahydrate are put in a stirring apparatus and dispersed evenly under 200 rpm for 50 min at 60° C. to obtain a copper sulfate solution:
in the second step, 1250 g of dodecyl dimethyl benzyl ammonium bromide is added into the copper sulfate solution made in the first step, and stirred under 150 rpm for 15 min at 30° ° C. until the solution becomes a transparent liquid; and
in the third step, the solution obtained in the second step is added to the reactor and 2500 ml of 84-disinfectant is added into the above solution, and the mixture is stirred under 100 rpm for 20 min at 28° C. to obtain a composition C.

The composition aqueous agentia of the present invention can be used for seed soaking (rice seeds) or spraying onto rice leaves in the application of controlling bacterial leaf streak of rice.

### Effect Examples

### 1. Indoor Antibacterial Test:

Compositions A, B, and C, as well as 84-disinfectant, dodecyl dimethyl benzyl ammonium bromide, and copper sulfate pentahydrate, are respectively diluted to 1:500, 1:1000, 1:1500, 1:2000 (v/v) using water. Sterile water serves as control. After pathogen of bacterial leaf streak (Xanthomonas oryzaes pv. Oryzicola: Institute of Plant Protection, Guangdong Academy of Agricultural Sciences) are grown on PSA oblique mediums (200 g potato, 20 g sucrose, 20 g agar, and 1000 ml distilled water, pH 5.6-6.6) for 2 d, the PSA oblique mediums (200 g potato, 20 g sucrose, 20 g agar, and 1000 ml distilled water, pH 5.6-6.6) are immersed into the above dilutions for 24 h and prepared as suspensions of bacteria. The bacterial suspension is centrifuged for 20 min at 4500 rpm. The precipitate is collected and washed with sterile water, and centrifuged again for 20 min at 4500 rpm. The precipitate is scribed on those treated PSA oblique mediums, and cultured. Each treatment has three replicates. The growth of pathogen of bacterial leaf streak of rice on PSA medium is observed and recorded after 3 d. The inhibition rate of bacterial growth is formulated as follows:

Inhibition rate of bacterial growth (%)=[(diameter of bacteriostatic circle of control−diameter of bacteriostatic circle of treatments)/diameter of bacteriostatic circle of control]×100.

If the pesticides have an inhibitory effect on the growth of pathogen of bacterial leaf streak of rice, the treated bacteria loses its vitality, and they are difficult to grow on PSA medium. Therefore, the stronger bacteriostatic ability the pesticides have, the bigger its dilution concentrations having inhibitory effect are.

The results for tests show that compositions A, B and C have stronger bactericdal power for the pathogen of bacterial leaf streak of rice, especially compositions B and C, which can inhibited the pathogen of bacterial leaf streak of rice by 100% at 1500 times of dilution and are considered as better compositions therebetween (Table 1). 84-disinfectant, dodecyl dimethyl benzyl ammonium bromide, and copper sulfate (raw material being crystalline copper sulfate pentahydrate) have a certain inhibitory effect on the pathogen. Comparing with compositions A, B, and C, however, their effects are poorer, indicating that these chemical compounds have a certain synergism effect after they are combined together. The synergism may be related to the copper complexes produced by those three compounds together.

TABLE 1
Effects of growth inhibition of compositions A, B
and C on pathogen of bacterial leaf streak of rice

| | | Inhibition rate |
|---|---|---|
| | Multiple | of bacterial |
| Name of preparation | for dilution | growth (%) |
| Compositions A | 500 | 100 |
| | 1000 | 90 |
| | 1500 | 85 |
| | 2000 | 80 |
| Compositions B | 500 | 100 |
| | 1000 | 100 |
| | 1500 | 100 |
| | 2000 | 91 |
| Compositions C | 500 | 100 |
| | 1000 | 100 |
| | 1500 | 100 |
| | 2000 | 89 |
| 84-disinfectant | 500 | 50 |
| | 1000 | 41 |
| | 1500 | 32 |
| | 2000 | 21 |
| Dodecyl dimethyl benzyl | 500 | 41 |
| ammonium bromide | 1000 | 32 |
| | 1500 | 30 |
| | 2000 | 23 |
| Copper sulfate | 500 | 50 |
| | 1000 | 46 |
| | 1500 | 43 |
| | 2000 | 32 |
| Sterile water | 0 | 0 |

### 2. Safety Test of Pesticides on Rice Seeds and Seedling Growth:

Rice seeds are soaked in 1500 times or 2000 times dilutions of compositions A, B, and C for 24 h, and sterile water serves as a control. 2 g of soaked seeds are germinated on one dish, and each treatment is replicated three times. The dishes are placed under an illumination of 12 h/d at a temperature of 28° C. After 6 d, the seeds are tested for germination rate, bud length and root length (Shao Zhihui et al., Journal of Ecology 2005, 24 (12): 1440˜ 1443). The results for test showed that compositions A and B have no inhibitory effects on rice seed germination and seedling growth, indicating that the three compositions are safe for rice. These compositions can be used for seed soaking, seedling stage, and field use. In contrast, 84-disinfectant, dodecyl dimethyl benzyl ammonium bromide and copper sulfate have inhibitory effects on rice seed germination and seedling growth, however, they easily produce pesticide toxicity and are not suitable for rice singly.

TABLE 2
Results for safety tests of compositions
A, B and C used for rice seed soaking

| | | | Bud | Root |
|---|---|---|---|---|
| Name of | Multiple for | Germination rate | length | length |
| preparation | dilution | of seed (%) | (mm) | (mm) |
| Composition A | 1500 | 86 | 33 | 43 |
| | 2000 | 87 | 35 | 42 |
| Composition B | 1500 | 85 | 35 | 40 |
| | 2000 | 86 | 36 | 41 |
| Composition C | 1500 | 70 | 29 | 28 |
| | 2000 | 72 | 30 | 31 |
| 84-disinfectant | 1500 | 66 | 23 | 23 |
| | 2000 | 73 | 25 | 27 |
| Dodecyl dimethyl | 1500 | 55 | 21 | 20 |
| benzyl | 2000 | 56 | 26 | 28 |
| ammonium | | | | |
| bromide | | | | |
| Copper sulfate | 1500 | 50 | 19 | 18 |
| | 2000 | 52 | 20 | 21 |
| Sterile water | 0 | 85 | 33 | 43 |

### 3. Pesticide Application Test During the Seedling Stage:

Location: Green and net-house, Institute of Plant Protection, Guangdong Academy of Agricultural Sciences.
Rice varieties: Shuiyuan-290 (susceptible rice variety, provided by Institute of Plant Protection, Guangdong Academy of Agricultural Sciences).

Rice variety Shuiyuan-290 is grown in the green and net-house. Pathogen of bacterial leaf streak (concentration of 109 CFU/ml) is used to inoculate the seedlings at 3-leaf stage through foliar spray, and the inoculated seedlings are kept moistfor 12 h. After that, pesticides diluted by water in 1500 times or 2000 times of compositions A, B, and C as well as clean waterare sprayed onto the leaves of tested rice seedlings (with the usage of the diluted pesticides of 50 kg/mu). A second spray is performed after 10 d with the same pesticides and concentrations. Rate of diseased leaves is investigated 3 days after the last spray (i.e., the second spray). Each treatment is repeated three times.

$$Rate of diseased leaves ( \% ) = ( number of diseased leaves / total number of leaves investigated ) \times 100.$$

$$Control effect ( \% ) - [ ( Rate of diseased leaves in control - Rate of diseased leaves in treatment ) / Rate of diseased leaves in control ] \times 100.$$

With spray during rice seedling stage, the results for tests of the control effect of compositions A, B and C on bacterial leaf streak of rice show that, the 1500 times dilution of composition B has the best control effect on bacterial leaf streak of rice reaching 98.5% (Seeing Table 3).

TABLE 3
Control effect of compositions A, B and C on bacterial leaf
streak of rice with spray during rice seedling stage

| Name of | Multiple for | Control effect of |
|---|---|---|
| preparation | dilution | disease (%) |
| Composition A | 1500 | 86.1 |
| | 2000 | 81.2 |
| Composition B | 1500 | 98.5 |
| | 2000 | 91.2 |
| Composition C | 1500 | 98.3 |
| | 2000 | 95.1 |
| Clean water | 0 | 0 |

### 4. Field Test:

In the early stage of bacterial leaf streak of rice, 1500 times or 2000 times dilution of compositions A, B, and C is sprayed in fields (with the usage of dilutions of 50 kg/mu). The spray is conducted every 7 days, and three times in total. Investigation of disease rate and disease index is performed 7 days after the last spray, as is used to calculate the control effect.

Criteria of disease classification: grade 0, leaves without diseased spots; grade 1, diseased spot area≤ 1% leaf area; grade 3, 1% leaf area<diseased spot area≤5% leaf area; grade 5, 5% leaf area<diseased spot area≤25% leaf area; grade 7, 25% leaf area<diseased spot area≤50% leaf area, grade 9, disease spot area>50% leaf area.

$$Disease index ( indicating the severity of the disease hazard , being calculated according to the calculation formula ) = [ \sum ( disease grade value \times number of leaves ) \times 100 ] / ( 9 \times Number of investigated leaves ) .$$

$$Control effect ( \% ) = [ ( disease index in control - disease index in treatment ) / disease index in control ] \times 100.$$

The results for tests show that the 1500 times dilution of composition B has the best control effect on bacterial leaf streak of rice reaching 78.5% (Seeing Table 4).

TABLE 4
Control effects of compositions A, B and C on bacterial
leaf streak of rice with spray during rice field

| Name of preparation | Multiple for dilution | Control effect |
|---|---|---|
| Composition A | 1500 | 71.2 |
| | 2000 | 68.3 |
| Composition B | 1500 | 78.5 |
| | 2000 | 71.2 |
| Composition C | 1500 | 78.3 |
| | 2000 | 65.2 |
| Clean water | 0 | 0 |

The above examples are preferred embodiments of the present invention. However, the embodiments of the present invention are not limited to the above described examples, and any other modification, amendment, replacement, combination and simplification made without departing from the spirit and principle of the present invention shall all be the equivalent substitute mode, and all fall within the scope of protection of the present invention.

1. A composition for controlling bacterial leaf streak of rice, comprising the following components in percentage by weight: 10-15 parts of dodecyl dimethyl benzyl ammonium bromide, 15-20 parts of copper sulfate pentahydrate, 20-25 parts of 84-disinfectant, and 40-55 parts of water.

2. The composition for controlling bacterial leaf streak of rice according to claim 1, comprising the following components in percentage by weight: 10-13 parts of dodecyl dimethyl benzyl ammonium bromide, 15-18 parts of copper sulfate pentahydrate, 20-23 parts of 84-disinfectant, and 46-55 parts of water.

3. A method for preparing the composition for controlling bacterial leaf streak of rice according to claim 1, comprising the following steps:
(1) adding copper sulfate pentahydrate into water, and stirring and dispersing evenly at 50-60° C., to obtain a copper sulfate solution;
(2) adding dodecyl dimethyl benzyl ammonium bromide into the copper sulfate solution prepared in step (1), and stirring and mixing evenly, to obtain a transparent liquid A; and
(3) adding 84-disinfectant into the transparent liquid A prepared in step (2), and stirring and mixing evenly, to obtain the composition for controlling bacterial leaf streak of rice.

4. The method for preparing the composition for controlling bacterial leaf streak of rice according to claim 3, wherein
(1) the stirring in step 1 is performed under 100-200 rpm for 40-50 min;
(2) the stirring in step 2 is performed under 100-200 rpm for 15-30 min; and
(3) the stirring in step 3 is performed under 100-200 rpm for 15-30 min.

5. The method for preparing the composition for controlling bacterial leaf streak of rice according to claim 4, wherein
(1) the stirring in step 1 is performed under 200 rpm for 40-50 min;
(2) the stirring in step 2 is performed under 100-200 rpm for 15-30 min at room temperature; and
(3) the stirring in step 3 is performed under 100-200 rpm for 15-30 min at 25-30° C.

6. An application of the composition for controlling bacterial leaf streak of rice according to claim 1 in preparing a pesticide preparations for controlling bacterial leaf streak of rice.

7. An application of the composition for controlling bacterial leaf streak of rice according to claim 1 in controlling bacterial leaf streak of rice.

8. The application according to claim 7, wherein the composition for controlling bacterial leaf streak of rice is diluted by 500-2000 times, and used for controlling bacterial leaf streak of rice through rice seed soaking or spraying onto rice leaves.

9. The application according to claim 8, wherein
the usage of the diluted composition for controlling bacterial leaf streak of rice is 50 kg/mu; and
the multiple for dilution of the composition for controlling bacterial leaf streak of rice is 500-1500 times.

10. The application according to claim 8, wherein
the multiple for dilution of the composition for controlling bacterial leaf streak of rice is 1000-1500 times.
